(19) United States
(12) Patent Application Publication
(10) Pub. No.: US 2012/0006831 A1
(43) Pub. Date: Jan. 12, 2012

(54) MANUFACTURING METHOD FOR FOAM MOLDED ARTICLE AND PACKAGING MATERIAL

(75) Inventor: Takashi Kano, Aichi (JP)

(73) Assignee: A TECHNO DESIGN Co., Ltd., Kasugai-shi, Aichi (JP)

(21) Appl. No.: 13/257,430

(22) PCT Filed: Sep. 28, 2009
(86) PCT No.: PCT/JP2009/067297

§ 371 Date: Sep. 19, 2011

(30) Foreign Application Priority Data
Mar. 27, 2009 (JP) 2009-79778

(51) Int. Cl. B65D 6/28; B29C 44/12

(52) U.S. Cl. 220/600; 264/41

(57) ABSTRACT

An object of the present invention is to provide a method of manufacturing a foam molded article in which upstanding portions are formed on a peripheral edge of a main body portion inexpensively by greatly increasing a yield of a mold. To achieve this object, in a manufacturing method for a foam molded article, a plate surface of the main body portion on a side where the upstanding portions is molded by side surfaces 21b, 31b of a continuous projecting portion defined when a male mold 20 and a female mold 30 are clamped such that projecting portions 21, 31 formed respectively on the male mold 20 and the female mold 30 are inserted into each other alternately, and inner surfaces of the upstanding portions are molded by tip end surfaces 21a, 31a of the projecting portions inserted into each other alternately when the male mold and the female mold are clamped.

### TECHNICAL FIELD

The present invention relates to a manufacturing method for a foam molded article, and more particularly to a manufacturing method for a foam molded article in which upstanding portions for sandwiching a packaging subject or the like are provided on a peripheral edge of a main body portion, and a packaging material manufactured using this manufacturing method.

### BACKGROUND ART

An in-mold bead foam-molded article having a foamed synthetic resin such as foamed polystyrene, foamed polypropylene, or foamed polyethylene, for example, as a raw material is lightweight and exhibits superior impact resistance. Therefore, such in-mold bead foam molded articles are used widely in various types of packaging materials.

As shown in FIG. 8, for example, a left-right set of foam molded articles 100 in which an upstanding portion 101 is provided on a peripheral edge of a main body portion 102 is used to pack a gas hotplate. The foam molded articles 100 are attached to respective end portions of a gas hotplate G using the upstanding portions 101, whereupon the foam molded articles 100 are housed and thereby packaged in cardboard (not shown). In this case, the upstanding portions 101 formed on the foam molded articles 100 act to position and protect the end portions of the gas hotplate G. Further, the packaging subject G is sandwiched between the opposing upstanding portions 101, and therefore the upstanding portions 101 act to ensure that the foam molded articles 100 attached to the packaging subject G do not fall off easily on an automatic packaging line or the like. Note that 103 in the drawing denotes through holes drilled into a plate surface of the main body portion 102 in order to reduce bulk and so on.

The foam molded article 100 having the upstanding portion 101 formed on its peripheral edge in this manner is typically manufactured as follows using an automatic molding machine.

FIG. 9 is a schematic longitudinal sectional view showing a mold part installed in an automatic molding machine. In this automatic molding machine, a male mold 51 and a female mold 52 are fixed to respective frames 53, 54 so as to be disposed opposite each other, thereby forming a cavity 50 in which a foam molded article is charged and molded. The female mold 52 is fixed, whereas the male mold 51 is disposed to be capable of moving in a left-right direction of FIG. 9 so that molded foam molded articles can be extracted.

Using the automatic molding machine described above, a foam molded article is manufactured as follows. First, the male mold 51 and the female mold 52 are closed to form the cavity 50, whereupon pre-foamed raw material beads made of polystyrene or the like are charged into the cavity 50. Next, the raw material beads charged into the cavity are heated and melted by heating steam, whereby the beads are foamed and molded. A resulting foam molded body is then cooled, and after cooling, the molds are opened by moving the male mold 51 and a foam molded article molded into a predetermined shape is extracted from the molds.

When manufacturing the foam molded article 100 having the upstanding portion 101 on its peripheral edge using the method described above, the following points are taken into account to enable automatic molding, and in particular to ensure that the molded article can be extracted. As shown in FIG. 9, the male mold 51 and the female mold 52 are designed so that the upstanding portion 101 of the molded article 100 is formed parallel to an extraction direction. In other words, as shown in FIG. 10, for example, the mold is designed as a so-called planar extraction mold for extracting five left-right sets, in which a formation site of the main body portion 102 of the foam molded article 100 is disposed on a mold plate surface. Note that FIG. 10 is a schematic front view of the female mold 52, showing a condition prior to extraction of the foam molded articles 100 forming a single left-right set.

In the manufacturing method for a foam molded article having an upstanding portion on its peripheral edge according to the background art, described above, the formation site of the main body portion 102 having the greatest surface area is disposed on the mold plate surface. Therefore, a yield is limited, an amount of used energy per molded article is large, and a cycle time is long. As a result, with the manufacturing method for a foam molded article having an upstanding portion on its peripheral edge according to the background art, a manufacturing cost is high.

### DISCLOSURE OF THE INVENTION

The present invention has been designed in consideration of the problems in the background art described above, and an object thereof is to provide a method of manufacturing a foam molded article in which an upstanding portion is formed on a peripheral edge of a main body portion inexpensively by greatly increasing a yield of a mold.

Through committed research undertaken with the aim of achieving the object described above, the present inventor and so on found that the object can be achieved sufficiently when the upstanding portions for sandwiching the packaging subject or the like exist intermittently on the peripheral edge of the main body portion, and thereby arrived at the present invention.

More specifically, the present invention is a manufacturing method for a foam molded article and a packaging material according to following points (1) to (6).

(1) A manufacturing method for a foam molded article in which an upstanding portion is formed on a peripheral edge of a main body portion, wherein a plate surface of the main body portion on a side where the upstanding portion is molded by a side surface of a continuous projecting portion defined when a male mold and a female mold are clamped such that projecting portions formed respectively on the male mold and the female mold are inserted into each other alternately, and an inner surface of the upstanding portion is molded by tip end surfaces of the projecting portions inserted into each other alternately when the male mold and the female mold are clamped.
(2) A packaging material manufactured using the manufacturing method for a foam molded article described in (1), and having intermittent upstanding portions formed on a peripheral edge of a main body portion.
(3) The packaging material described in (2), wherein the main body portion is substantially rectangular, first opposing upstanding portions are formed intermittently and alternately on the main body portion, and second opposing upstanding portions are formed continuously on the main body portion.
(4) The packaging material described in (3), wherein the first opposing upstanding portions are upstanding portions opposing each other in a lengthwise direction.
(5) The packaging material described in (3), wherein the second opposing upstanding portions are L-shaped upstanding portions formed continuously on one end with the first opposing upstanding portions.
(6) The packaging material described in (5), wherein corner portions of the opposing L-shaped upstanding portions are disposed so as to be positioned in a diagonal direction of the main body portion.

With the manufacturing method for a foam molded article according to the present invention, described above, a so-called longitudinal extraction mold, in which a formation site of the main body portion of the foam molded article is disposed perpendicular to a mold plate surface, can be designed, and therefore a yield of the mold can be increased greatly. Hence, according to the present invention, a foam molded article in which an upstanding portion is formed on a peripheral edge of a main body portion can be manufactured inexpensively.

### BRIEF DESCRIPTION OF THE DRAWINGS

FIG. 1 is a perspective view showing an example of a packaging material manufactured using a manufacturing method for a foam molded article according to the present invention, and a view showing a right-hand packaging material that is attached to a right side of a gas hotplate serving as a packaging subject;

FIG. 2 is a perspective view showing an example of the packaging material manufactured using the manufacturing method for a foam molded article according to the present invention, and a view showing a left-hand packaging material that is attached to a left side of the gas hotplate serving as the packaging subject;

FIG. 3 is a schematic sectional view showing a structure of a mold for molding a part extending along a I-I line in FIG. 1 in a clamped condition;

FIG. 4 is a schematic sectional view showing a structure of a mold for molding a part extending along a II-II line in FIG. 1 in a clamped condition;

FIG. 5 is a schematic sectional view showing a structure of a mold for molding a part extending along a III-III line in FIG. 1 in a clamped condition;

FIG. 6 is a front view of a female mold used in the manufacturing method for a foam molded article according to the present invention, and a schematic view showing a condition prior to extraction of the foam molded article;

FIG. 7 is a perspective view showing a condition before the packaging material according to the present invention is attached to the gas hotplate serving as the packaging subject;

FIGS. 8(a) and 8(b) are perspective views respectively showing conditions before and after a conventional packaging material is attached to a gas hotplate serving as a packaging subject;

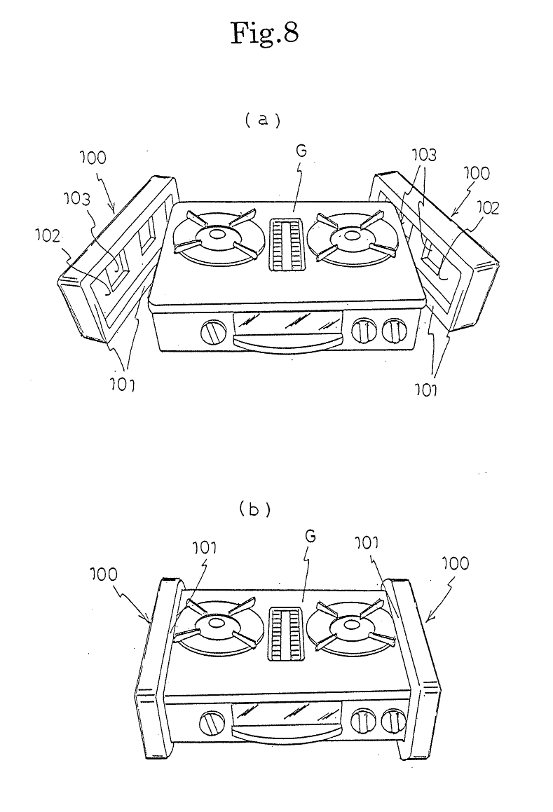

FIG. 9 is a schematic longitudinal sectional view showing an automatic molding machine installed with a mold used in a conventional manufacturing method for a foam molded article; and

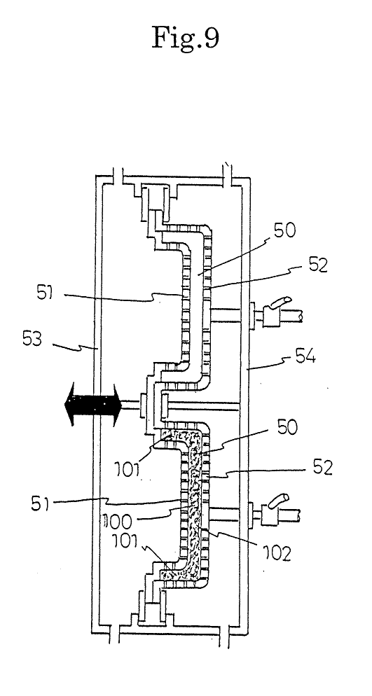

FIG. 10 is a front view of a female mold used in the conventional manufacturing method for a foam molded article in a condition prior to extraction of the foam molded article.

### BEST MODE FOR CARRYING OUT THE INVENTION

An embodiment of a manufacturing method for a foam molded article and a packaging material according to the present invention will be described in detail below on the basis of the drawings.

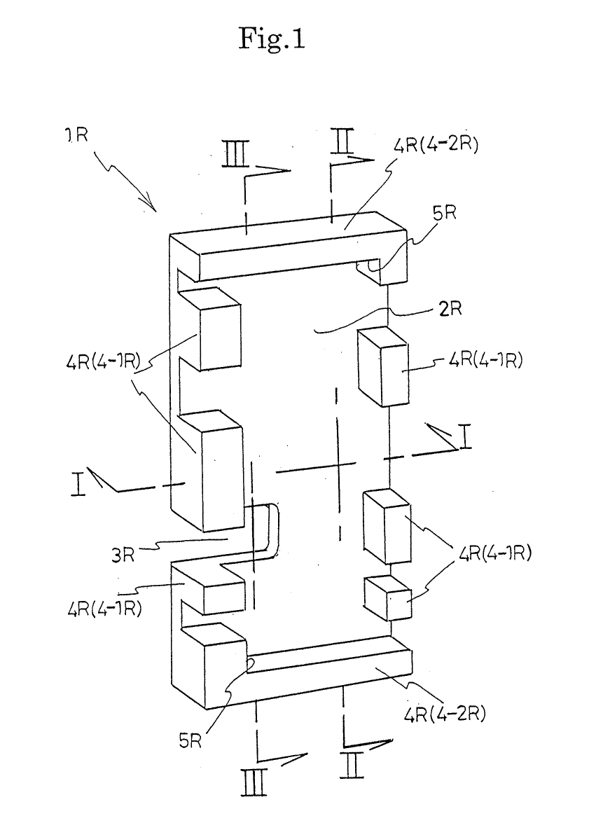

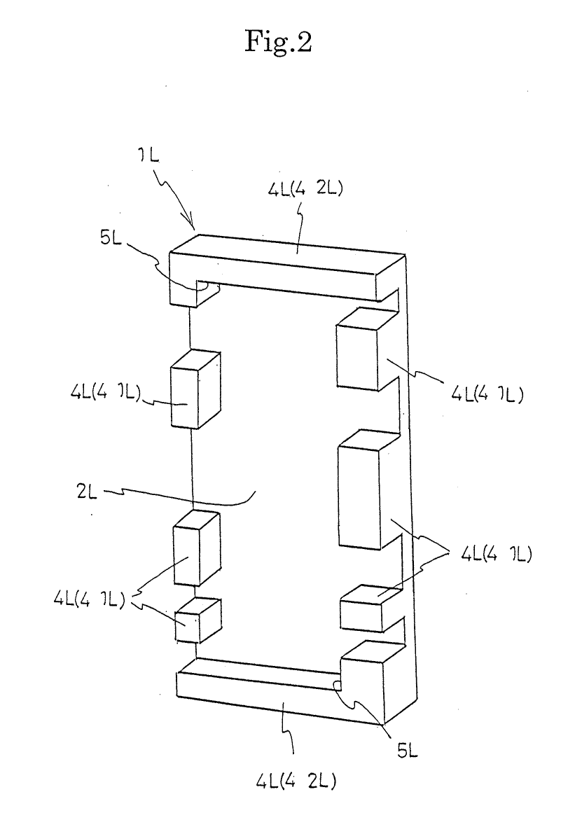

FIGS. 1 and 2 are perspective views showing examples of packaging materials manufactured using the manufacturing method for a foam molded article according to the present invention. FIG. 1 shows a right-hand packaging material attached to a right side of a gas hotplate serving as a packaging subject, and FIG. 2 shows a left-hand packaging material attached to a left side of the gas hotplate serving as the packaging subject. The right-hand packaging material and the left-hand packaging material together form one set. A right-hand packaging material 1R and a left-hand packaging material 1L have substantially symmetrical shapes, but the right-hand packaging material 1R differs in that a cut out recess portion is formed in a main body portion thereof. The following description focuses on the shape of the right-hand packaging material 1R and a manufacturing method thereof. As regards the left-hand packaging material 1L, identical members and parts are allocated identical Arabian numerals but affixed with the letter L indicating the left-hand packaging material in place of the letter R indicating the right-hand packaging material, and in certain cases, description thereof is omitted.

As shown in FIG. 1, the right-hand packaging material 1R includes a substantially rectangular main body portion 2R, a cut out recess portion 3R formed in a plate surface of the main body portion 2R, and an upstanding portion 4R formed on a peripheral edge of the main body portion 2R. The right-hand packaging material 1R is molded integrally by in-mold bead foaming using a foamed synthetic resin such as foamed polystyrene, foamed polypropylene, or foamed polyethylene, for example, as a raw material.

Upstanding portions 4-1R opposing each other in a lengthwise direction are formed intermittently and alternately on the main body portion 2R. On the other hand, upstanding portions 4-2R opposing each other in a widthwise direction are formed continuously on the main body portion 2R. Further, the upstanding portions 4-2R opposing each other in the widthwise direction are L-shaped upstanding portions formed continuously on one end with the upstanding portions 4-1R opposing each other in the lengthwise direction. The opposing L-shaped upstanding portions 4-2R are formed on the main body portion 2R such that corner portions 5R thereof are positioned in a diagonal direction of the main body portion 2R.

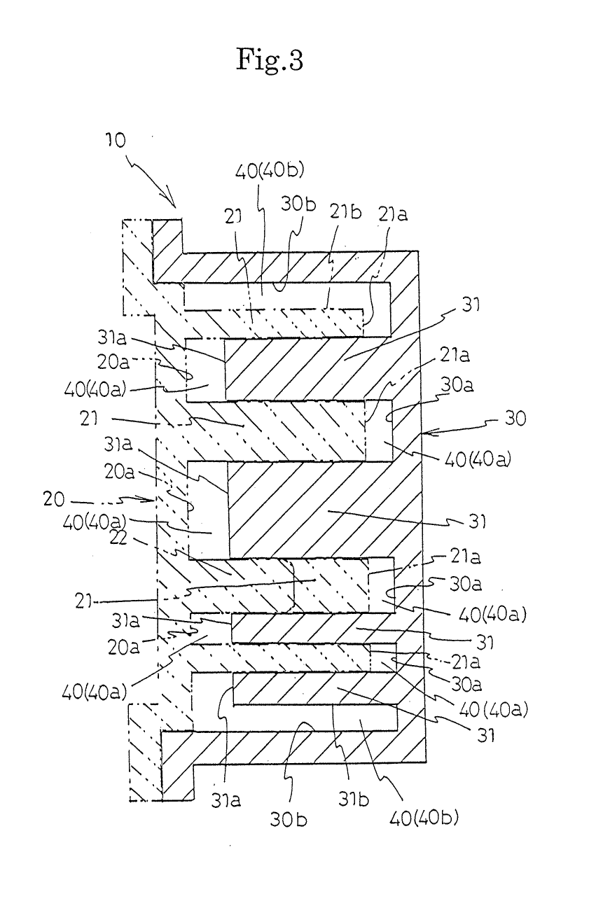

The right-hand packaging material 1R shaped as described above is manufactured using a mold having a structure shown in FIGS. 3 to 5. Note that FIGS. 3, 4, and 5 are schematic sectional views showing the structure of a mold for molding a part extending along a I-I line in FIG. 1, a structure of a mold for molding a part extending along a II-II line in FIG. 1, and a structure of a mold for molding a part extending along a III-III line in FIG. 1, respectively, in a clamped condition.

A mold 10 is constituted by a male mold 20 and a female mold 30. Pre-foamed raw material beads are charged into a cavity 40 formed between the two molds 20, 30 when the molds are clamped, whereupon heat is applied such that the charged raw material beads are molded into a predetermined shape.

Projecting portions 21, 31 are formed respectively on the male mold 20 and the female mold 30. The projecting portions 21, 31 are inserted into each other alternately when the molds are clamped. Thus, as shown in FIG. 3, cavities 40a for forming the respective upstanding portions 4-1R are defined between tip end surfaces 21a, 31a of the alternately inserted projecting portions and bottom surfaces 20a, 30a of the molds. Further, cavities 40b for forming the L-shaped upstanding portions 4-2R are defined between an inner peripheral surface 30b of the female mold and the tip end surfaces 21a, 31a and side surfaces 21b, 31b of the inserted projecting portions.

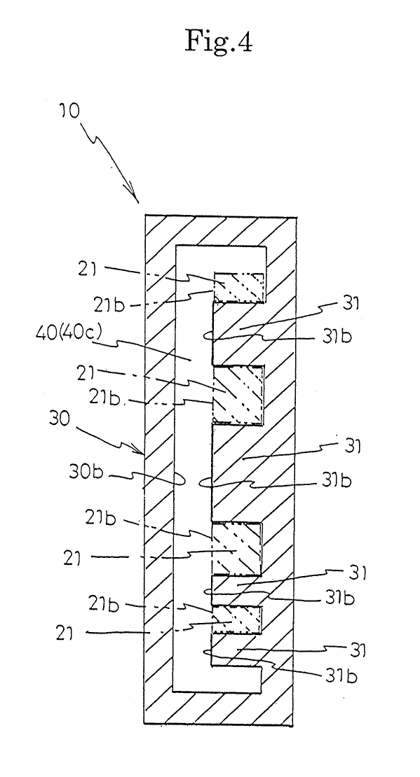

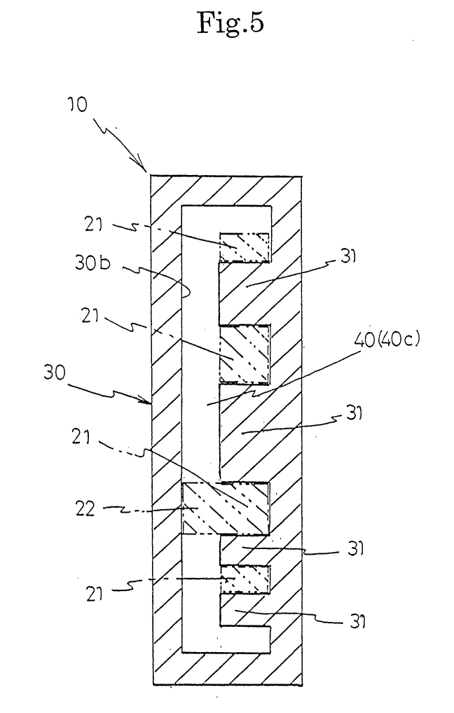

Furthermore, as shown in FIG. 4, a cavity 40c for forming the substantially rectangular main body portion 2R is defined between the continuous side surfaces 21b, 31b of the projecting portions 21, 31 that are inserted into each other alternately when the molds are clamped and the inner peripheral surface 30b of the female mold. Moreover, as shown in FIGS. 3 and 5, the cut out recess portion 3R is formed in the plate surface of the main body portion 2R by a projection 22 formed on one of the projecting portions 21 of the female mold.

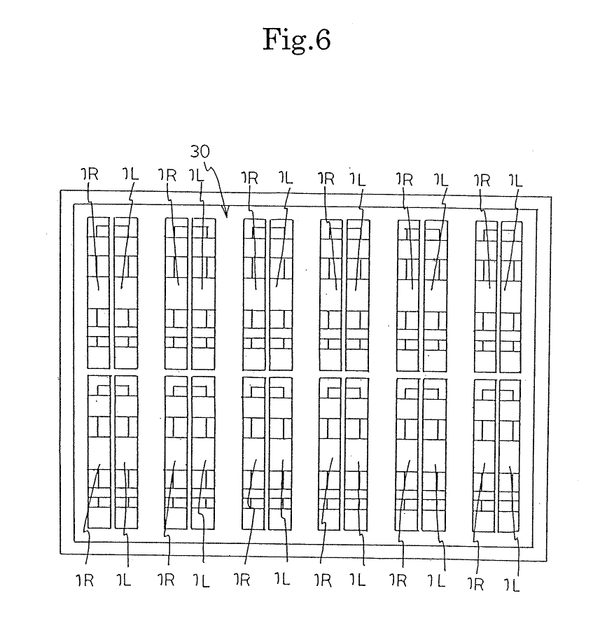

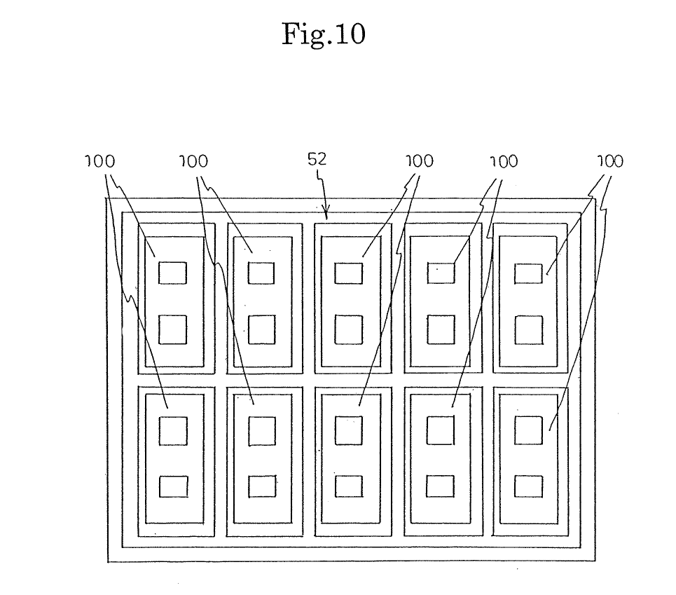

The mold structured as described above is a so-called longitudinal extraction mold in which a formation site of the main body portion 2R of the foam molded article is disposed perpendicular (in an extraction direction) to the mold plate surface. Therefore, as shown in FIG. 6, it is possible to design a twelve left-right set extraction mold (the conventional mold shown in FIG. 10 is a five left-right set extraction mold) from molds having identical mold plate surface areas installed in an automatic molding machine shown in FIG. 10, for example. As a result, an amount of used energy and a cycle time per molded article can be reduced greatly, enabling a reduction in manufacturing cost. Note that FIG. 6 is a schematic front view of the female mold 30, showing a condition prior to extraction of a foam molded article constituted by a set of the right-hand packaging material 1R and the left-hand packaging material 1L. Further, the mold may be structured to be capable of molding the right-hand and left-hand packaging materials 1R, 1L in a partially coupled split form.

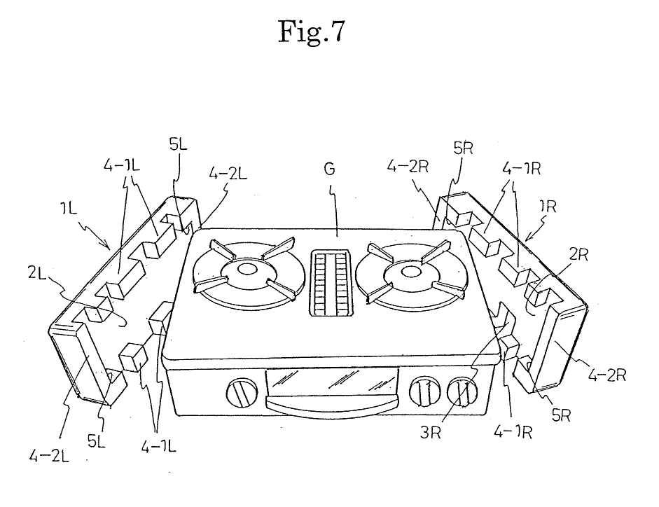

In the packaging materials 1R, 1L manufactured using the manufacturing method described above, the upstanding portions 4-1R, 4-1L opposing each other in the lengthwise direction are formed intermittently and alternately on the main body portions 2R, 2L. However, even when the packaging materials 1R, 1L have this shape, end portions of the gas hotplate G serving as the packaging subject can be sandwiched between the upstanding portions sufficiently, as shown in FIG. 7, and therefore the function of the packaging materials is not impaired. Further, the upstanding portions 4-2R, 4-2L opposing each other in the widthwise direction are formed in an L shape, and the corner portions 5R, 5L of the L shapes are disposed so as to be positioned in the diagonal direction of the main body portions 2R, 2L. Hence, corner portions of the gas hotplate G serving as the packaging subject can be protected, and a favorable balance can be obtained in the strength of the packaging material. Furthermore, the cutout recess portion 3R is formed in the main body portion 2R of the right-hand packaging material 1R, and therefore a lot number and so on of the gas hotplate G can be read through the cut out recess portion 3R even after the packaging material 1R is attached to the gas hotplate G.

An embodiment of the manufacturing method for a foam molded article and the packaging material according to the present invention was described above, but the present invention is not limited to this embodiment.

In particular, as long as the mold is structured such that the plate surface of the molded main body portion on the side for forming the upstanding portions is molded by the side surface of the continuous projecting portion defined when the male mold and the female mold are clamped such that the projecting portions formed respectively thereon are inserted into each other alternately, and inner surfaces of the upstanding portions are molded by the tip end surfaces of the projecting portions inserted into each other alternately when the male and female molds are clamped, other structures are not limited to the embodiment.

Further, the shape of the packaging material is merely an example, and projecting ribs for providing reinforcement or the like may be formed on the plate surface of the main body portion on the side where the upstanding portions are formed, for example. Furthermore, step portions may be formed on the inner surface side of the upstanding portions formed intermittently and alternately on the main body portion. To form projecting ribs on the plate surface of the main body portion, the mold should be designed such that recess portions are formed when the molds are clamped by the aligned side surfaces of the projecting portions formed on the male mold or the female mold. Further, to form step portions on the inner surface side of the upstanding portions, step portions should be formed on the tip ends of the projecting portions formed on the male mold or the female mold.

### INDUSTRIAL APPLICABILITY

The manufacturing method for a foam molded article according to the present invention, described above, can be used widely to manufacture in-mold bead foam-molded articles in which a foamed synthetic resin such as foamed polystyrene, foamed polypropylene, or foamed polyethylene, for example, is used as a raw material and upstanding portions for sandwiching a packaging subject or the like are formed on a peripheral edge of a main body portion. Further, the packaging material manufactured using the manufacturing method for a foam molded article according to the present invention can be used widely as a packaging material for various products.

1. A manufacturing method for a foam molded article in which an upstanding portion is formed on a peripheral edge of a main body portion,
the method being characterized in that
a plate surface of said main body portion on a side where said upstanding portion is molded by a side surface of a continuous projecting portion defined when a male mold and a female mold are clamped such that projecting portions formed respectively on said male mold and said female mold are inserted into each other alternately, and an inner surface of said upstanding portion is molded by tip end surfaces of said projecting portions inserted into each other alternately when said male mold and said female mold are clamped.

2. A packaging material, manufactured using the manufacturing method for a foam molded article according to claim 1, and comprising intermittent upstanding portions formed on a peripheral edge of a main body portion.

3. The packaging material according to claim 2, characterized in that said main body portion is substantially rectangular, first opposing upstanding portions are formed intermittently and alternately on said main body portion, and second opposing upstanding portions are formed continuously on said main body portion.

4. The packaging material according to claim 3, characterized in that said first opposing upstanding portions are upstanding portions opposing each other in a lengthwise direction.

5. The packaging material according to claim 3, characterized in that said second opposing upstanding portions are L-shaped upstanding portions formed continuously on one end with said first opposing upstanding portions.

6. The packaging material according to claim 5, characterized in that corner portions of said opposing L-shaped upstanding portions are disposed so as to be positioned in a diagonal direction of said main body portion.
